(19) United States
(12) Patent Application Publication
(10) Pub. No.: US 2009/0116332 A1
(43) Pub. Date: May 7, 2009

(54) MULTI-FUNCTIONAL FUEL MIXING TANK

(76) Inventors: Hsi-Ming Shu, Taipei (TW); Tsang-Ming Chang, Taipei (TW); Chien-An Chen, Kaohsiung (TW); Wen Jui Chuang, Kaohsiung (TW)

Correspondence Address: G. LINK CO., LTD., 3550 BELL ROAD, MINOOKA, IL, 60447, US

(21) Appl. No.: 11/934,088

(22) Filed: Nov. 2, 2007

(51) Int. Cl. B01F 15/06; B01F 15/00

(52) U.S. Cl. 366/144; 366/150.1; 366/341

(57) ABSTRACT

The present invention discloses a multi-functional fuel mixing tank, which comprises: a case, a condenser, a fan, a first sheet, and a second sheet; wherein, the case is configured with a first accommodation portion, a second accommodation portion, a third accommodation portion, a first channel, a second channel, a third channel, a fourth channel, a fuel inlet, an air inlet, a fuel outlet, and a product inlet. The fuel inlet, the air inlet, the fuel outlet and the product inlet are configured on the sidewall of the case. The second accommodation portion is used as a mixing tank. The first channel is connected with the fuel inlet and the second accommodation portion. The fourth channel is connected with the first accommodation portion and the second accommodation portion. The condenser is fixed with the first accommodation portion, and used to condense the steam from the air inlet into water, and the condensed water flows to the second accommodation portion through the third channel and the second channel. The fan is fixed with the third accommodation portion, and used to reduce the temperature of the condenser. The first sheet and the second sheet are tightly joined on the upper surface and the lower surface of the case.

### FIELD OF THE INVENTION

The present invention relates to a mixing tank for fuel cell, and particularly to a multi-functional fuel mixing tank.

### BACKGROUND OF THE INVENTION

The US patent laid-opened publication US2004/( )115506, titled “Mixing tank for fuel cell”, and the US patent laid-opened publication US2004/0166389, titled “Fuel cell system”, have disclosed how to apply the mixing tank to the fuel cell. The mixing tank could be used to recycle the water generated by the fuel cell, and recycle the remaining fuel not conducted with electrochemical reaction.

Although the prior art has taught the function of the mixing tank, it did not provide how to integrate the condenser, the mixing tank, and other components, such as water level gauge, density detector, one-way valve, into a single-unit integral structure.

In view of the mixing tank in the prior art needed to be improved with the inherent structural insufficiency, the inventor of the present invention worked hard to invent for the improvement of a multi-functional fuel mixing tank.

### SUMMARY OF THE INVENTION

The object of the present invention is to provide a multi-functional mixing tank, which integrates the mixing tank with the condenser as a whole, and configures with the water level gauge, the density detector and the one-way valve to enhance the functionality.

To this end, the present invention provides a multi-functional fuel mixing tank, which comprises: a case, a condenser, a fan, a first sheet, and a second sheet; wherein, the case is configured with a first accommodation portion, a second accommodation portion, a third accommodation portion, a first channel, a second channel, a third channel, a fourth channel, a fuel inlet, an air inlet, a fuel outlet, and a product inlet. The fuel inlet, the air inlet, the fuel outlet and the product inlet are configured on the sidewall of the case. The fuel inlet is confronted with the first accommodation portion, and the product inlet is connected with the second accommodation portion. The second accommodation portion is used as a mixing tank. The first channel is used to connect with the fuel inlet and the second accommodation portion. The fourth channel is used to connect with the first accommodation portion and the second accommodation portion. The condenser is fixed with the first accommodation portion, and used to condense the steam from the air inlet into water, and the condensed water flows to the second accommodation portion through the third channel and the second channel. The fan is fixed with the third accommodation portion, and used to reduce the temperature of the condenser. The first sheet and the second sheet are tightly joined on the upper surface and the lower surface of the case.

### BRIEF DESCRIPTION OF THE DRAWINGS

The structure, features and effects according to the present invention could be further recognized and understood with the detailed description of the preferred embodiments and figures as follows, wherein:

FIG. 1 is a structural block diagram for the multi-functional fuel mixing tank according to the present invention;

FIG. 2 is a three-dimensional exploded diagram for the multi-functional fuel mixing tank according to the present invention;

FIG. 3 is a three-dimensional assembly diagram for the multi-functional fuel mixing tank according to the present invention;

FIG. 4 is a three-dimensional assembly diagram from another view for the multi-functional fuel mixing tank according to the present invention; and

FIG. 5 is a three-dimensional diagram of the joint configured on the first sheet for the multi-functional fuel mixing tank according to the present invention.

### DETAILED DESCRIPTION OF THE INVENTION

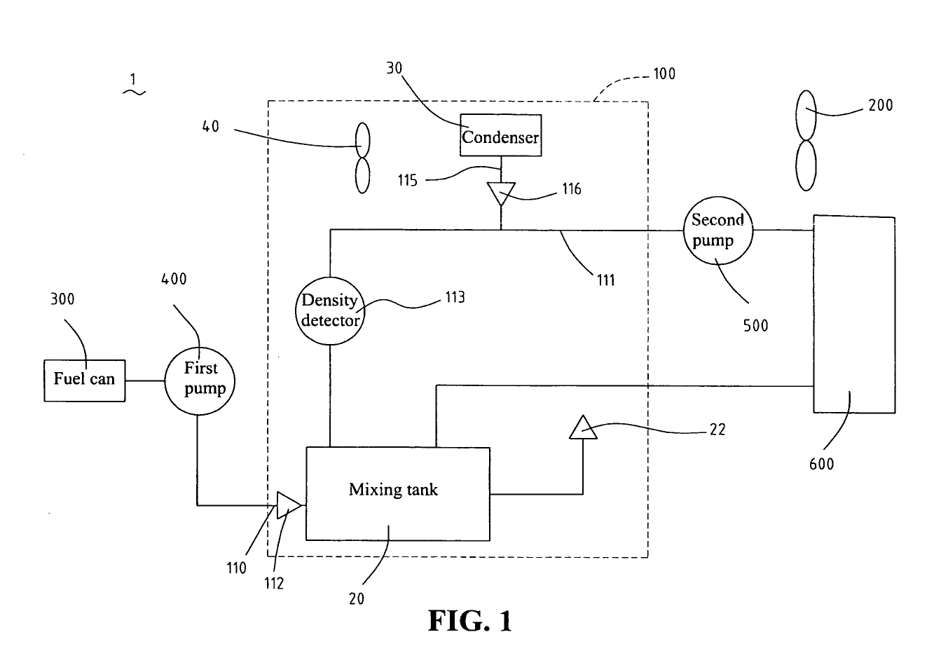

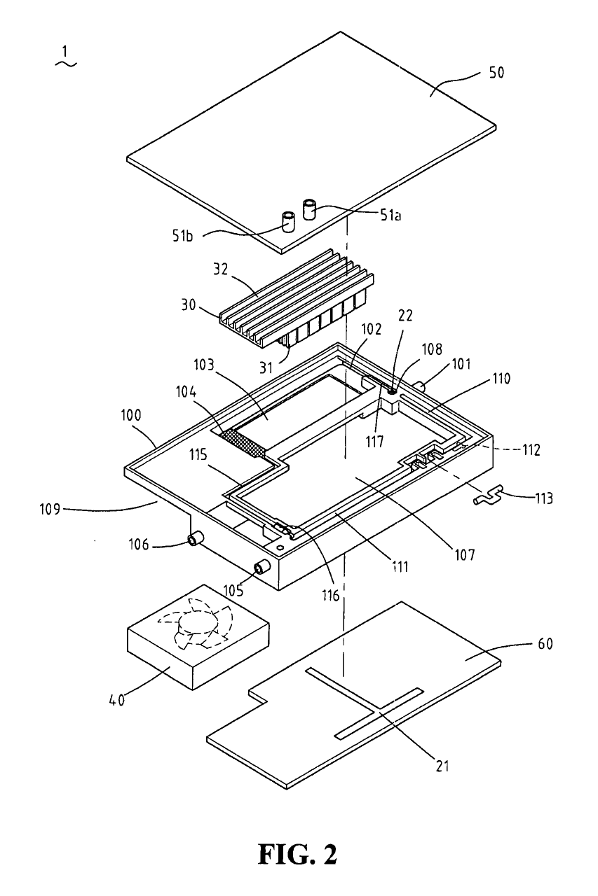

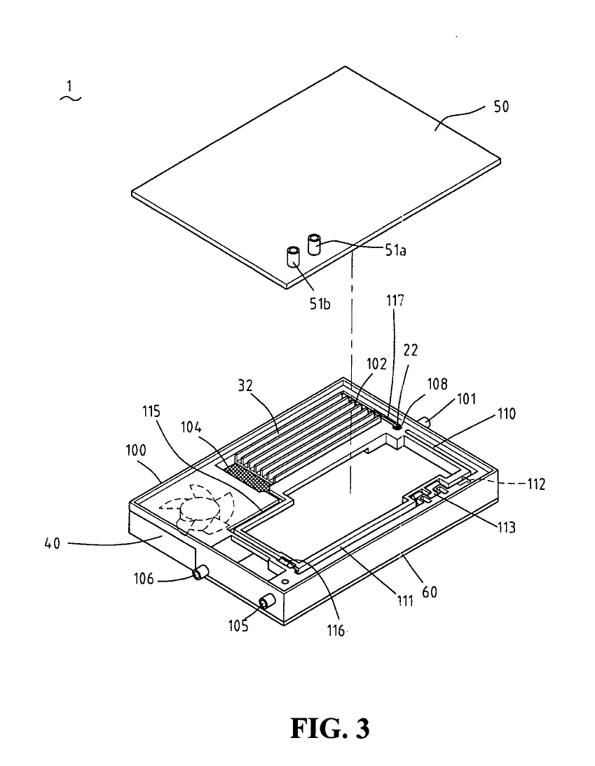

Please refer to FIG. 1, FIG. 2 and FIG. 3. The multi-functional fuel mixing tank 1 according to the present invention is a container structure composed of a case 100, a first sheet 50, and a second sheet 60, and the container structure is configured with a first accommodation portion 103, a second accommodation portion 107 and a third accommodation portion 109 forming three independent spaces. Also, the periphery of the case 100 is configured with a first channel 110, a second channel 111, a third channel 115, and a fourth channel 117. Of course, the multi-functional fuel mixing tank 1 also comprises a condenser 30 and a fan 40. The components and their functions are detailed described respectively in the following context.

The case 100 employs a rectangular structure, and the upper surface and the lower surface of the case 100 are tightly joined with the first sheet 50 and the second sheet 60. The sidewall of the case 100 is configured with the fuel inlet 101 and the air inlet 102. The air inlet 102 is confronted with the first accommodation portion 103 and tightly adjacent to the first accommodation portion 103. Another sidewall of the case 100 is configured with the fuel outlet 105 and the product inlet 106, and the product inlet 106 is connected with the second accommodation portion 107. The upper right location of the second accommodation portion 107 is configured with a hole 108, which is located at the intersection of the second accommodation portion 107 and the fourth channel 117. Both ends of the hole 108 are connected with the ends of the second accommodation portion 107 and the fourth channel 117, respectively. The other end of the fourth channel 117 is connected with the first accommodation portion 103.

The pressure relief valve 22 is placed in the hole 108. When the internal pressure of the second accommodation portion 107 is too large, the gas with the second accommodation portion 107 will flow into the first accommodation portion 103 through the pressure relief valve 22 and the fourth channel 117.

The fuel inlet 101 is connected with the end of the first channel 110. The other end of the first channel 110 is connected with the second accommodation portion 107, and the channel space at this end is configured with a first one-way valve 112, and the one-way valve 112 only allows the fluid flowing to the second accommodation portion 107.

The end of the second channel 111 is connected with the second accommodation portion 107, and the channel space at this end is configured with a density detector 113. The other end of the second channel 111 is connected with the inlet of the second pump 500 through piping. The embedded density detector 113 is used to measure the density of the fuel toward the fuel cell stack 600. The measured fuel density could be provided for the control circuit (not shown). The density detector 113 used in the present invention could directly employ the conventional devices.

The end of the third channel 115 is connected with the first accommodation portion 103. The other end of the third channel 115 is connected with the inlet of the second one-way valve 116. The outlet of the second one-way valve 116 is connected with the second channel 111. The second one-way valve 116 only allows the fluid flowing to the second channel 111.

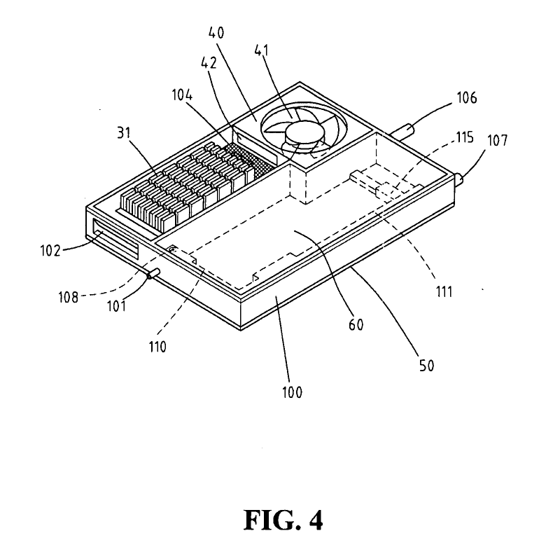

Please refer to FIGS. 3 and 4. The condenser 30 is fixed with the first accommodation portion 103. One face of the condenser 30 is formed with heat sink fins 31, and the other face is formed with channel structure 32. The channel structure 32 employs a plurality of parallel grooves, and one end of each groove is confronted with the air inlet 102. And the other end of each groove is connected with the third channel 115.

The second accommodation portion 107 is used as the mixing tank. The liquid stored in the mixing tank 107 is from the new fuel from the fuel can 300, the condensed water from the condenser 30, the anode product from the fuel cell stack 300, and the remaining anode fuel.

Please refer to FIG. 4. The fan 40 is fixed with the third accommodation portion 109. The fan 40 could introduce the outside air from the air inlet 41, and turn to blow out from the air outlet 42, and blow toward the heat sink fins 31 of the condenser 30, so that the entire condenser 30 could be kept at lower temperature.

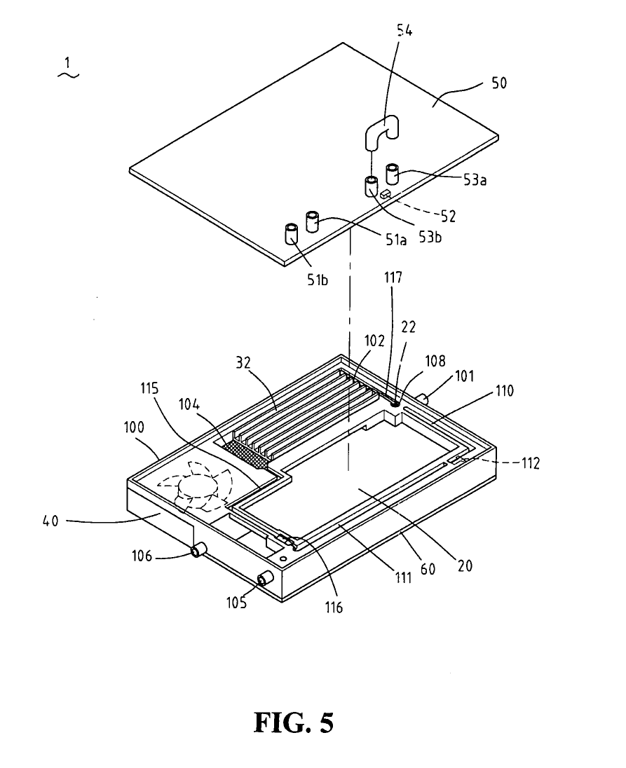

Please refer to FIGS. 4 and 5. The intersection of the first accommodation portion 103 and the third accommodation portion 109 is configured with a gas-permeable liquid-proof film 104. Thus, the internal air in the first accommodation portion 103 could escape to the outside through the gas-permeable liquid-proof film 104.

Please refer to FIG. 5. The first sheet 50 is tightly joined with the periphery of the upper surface of the case 100. Moreover, the location on the first sheet 50 corresponding to the second channel 111 is configured with two joint pipes 53a, 53b, and the joint pipes 53a, 53b penetrate through the first sheet 50 and are spaced with a small distance. And, the lower surface of the first sheet 50 located between the two joint pipes 53a, 53b is configured with a block 52. The block 52 would extend to the second channel 111, and block the connection of the second channel 111. Both ends of the external density detector 54 are connected with the two joint pipes, respectively. When the fuel of the second channel 111 are flowing through the block 52, due to the blocked effect by the block 52, the fuel would turn and flow to the joint pipe 53a, the external density detector 54, the joint pipe 53b, and then into the second channel 111. The external density detector 54 is used to measure the density of the fuel flowing to the fuel cell stack 600. The measured fuel density could be provided for the control circuit (not shown). The external density detector 54 used in the present invention could directly employ the conventional devices.

In order for the operational convenience of connection of the pipe of the second pump 500 with the multi-functional fuel mixing tank 1 according to the present invention, both locations, that is the end of the first sheet 50 corresponding to the second channel 111 and the end of the fuel outlet 105, are configured with two joint pipes 51a, 51b, respectively. The two joint pipes 51a, 51b penetrate through the first sheet. The joint pipe 51a is connected with the end of the second channel 111, and the joint pipe 51b is connected with the end of the fuel outlet 105. The inlet of the second pump 500 is connected with the joint pipe 51a through piping, and the outlet of the second pump 500 is connected with the joint pipe 51b through piping.

The water level gauge 21 could be configured on the inner surface of the second sheet 60. Please refer to FIG. 2. Or, the water level gauge 21 could be configured in the mixing tank 107. The water level gauge 21 is contacted with the fuel in the mixing tank 107. And, no matter the multi-functional fuel mixing tank 1 is placed horizontally or vertically, the water level gauge 21 could both measure the liquid level height under two placements. The measured liquid level height could be provided for the control circuit (not shown). The water level gauge 21 used in the present invention could directly employ the conventional devices.

Next, the multi-functional fuel mixing tank 1 according to the present invention would be described about how to operate with the fan 200, the fuel can 300, the first pump 400, the second pump 500 and the fuel cell stack 600.

The anode fuel inlet and the anode fuel outlet of the fuel cell stack 600 are connected with one end of the fuel cell outlet 105 and the product inlet 106 of the multi-functional fuel mixing tank 1 through piping.

The first pump 400 is configured in the piping between the fuel can 300 and the fuel inlet 101. With the thrust power of the first pump 400, the new fuel from the fuel can 300 would pass the first channel 110 and the first one-way valve into the mixing tank 107.

The second pump 500 is configured in the piping between the end of the second channel 111 and the end of the fuel outlet 105. The inlet of the second pump 500 is connected with the end of the second channel 111 (i.e. joint pipe 51a) through piping, and the outlet of the second pump 500 is connected with one of the ends (i.e. joint pipe 51b) of the fuel outlet 105 through piping. With the thrust power of the second pump 500, the fuel from the mixing tank 107 would flow into the fuel cell stack 600 through the second channel 110, the fuel outlet 105, and the anode fuel inlet of the fuel cell stack 600; next, the anode product and the remaining anode fuel would flow out from the anode fuel outlet of the fuel cell stack 600, and pass through the product inlet 106 and into the mixing tank 107. The fuel in the mixing tank 107 could employ the second pump 500 to be circulated flowing in the fuel cell stack 600.

The fan 200 could introduce the cathode product, such as steam, generated by the fuel cell stack 600 and the remaining cathode fuel, such as air or oxygen, to the air inlet 102, and flow through the channel structure 32 of the condenser 30. The steam would be condensed to liquid water under the condensing effect of the condenser 30. The recycled water would pass through the third channel 115, the second one-way valve 116, and the second channel 111, and finally flow into the mixing tank 107.

The multi-functional fuel mixing tank according to the present invention is provided with the following advantages and substantial effects and improvements as follows:

1. The multi-functional fuel mixing tank according to the present invention could integrate the mixing tank with the condenser as a whole, and successfully realize the compact and slim specification due to excellent structural design;
2. The multi-functional fuel mixing tank according to the present invention is configured with multiple one-way valve to prevent the reversed flow of the fluid; and
3. The multi-functional fuel mixing tank according to the present invention is configured with a density detector and a water level gauge to enhance the overall functionality.

The above description is only the preferred embodiment according to the present invention, which could not be used to limit the application range of the present invention, and the skilled in the art could obviously make changes and modification, which should be treated without departing from the substantial content of the present invention.

What is claimed is:

1. A multi-functional fuel mixing tank, which comprises:
a case, including a first accommodation portion, a second accommodation portion, a third accommodation portion, a first channel, a second channel, a third channel, a fourth channel, a fuel inlet, an air inlet, a fuel outlet, and a product inlet, wherein the fuel inlet, the air inlet, the fuel outlet and the product inlet are configured on the sidewall of the case, and the air inlet is confronted with the first accommodation portion, and the product inlet is connected with the second accommodation portion,
wherein the second accommodation portion is used as a mixing tank,
wherein the first channel is used to connect with the fuel inlet and the second accommodation portion,
wherein the fourth channel is used to connect with the first accommodation portion and the second accommodation portion;
a condenser, which is fixed with the first accommodation portion, and used to condense the steam from the air inlet into water, wherein the condensed water will flow into the second accommodation portion through the third channel and the second channel;
a fan, which is fixed with the third accommodation portion, and used to reduce the temperature of the condenser; and
a first sheet and a second sheet, which are tightly joined with the upper surface and the lower surface of the case.

2. The multi-functional fuel mixing tank according to claim 1, wherein the second accommodation portion is provided with a hole, and the hole is configured at the intersection of the second accommodation portion and the fourth channel, in which the hole is used to place with a pressure relief valve.

3. The multi-functional fuel mixing tank according to claim 1, wherein one face of the condenser is formed with a heat sink fin, and the other face is formed as a channel structure.

4. The multi-functional fuel mixing tank according to claim 1, further comprises a first one-way valve, which is configured in the first channel.

5. The multi-functional fuel mixing tank according to claim 1, further comprises a second one-way valve, which is configured in the third channel.

6. The multi-functional fuel mixing tank according to claim 1, further comprises a density detector, which is configured in the second channel.

7. The multi-functional fuel mixing tank according to claim 1, further comprises a water level gauge, which is used to contact with the fuel in the second accommodation portion for measuring the liquid level height of the fuel.

8. The multi-functional fuel mixing tank according to claim 1, further comprises an external density detector, which is connected outside the multi-functional fuel mixing tank through piping, and connected with the second channel through piping.

9. The multi-functional fuel mixing tank according to claim 1, wherein the fuel inlet is connected with the first pump through piping, and the first pump is further connected with a fuel can piping.

10. The multi-functional fuel mixing tank according to claim 1, wherein one of the ends of the second channel is connected with a second pump through piping, and the second pump is further connected with the anode fuel inlet of a fuel cell stack through piping.

11. The multi-functional fuel mixing tank according to claim 10, wherein the product inlet is connected with the anode fuel outlet of the fuel cell stack through piping.

12. The multi-functional fuel mixing tank according to claim 1, further comprises a gas-permeable liquid-proof film, which is configured at the intersection of the first accommodation portion and the third accommodation portion.
